(19) United States
(12) Patent Application Publication
(10) Pub. No.: US 2025/0118197 A1
(43) Pub. Date: Apr. 10, 2025

(54) METHOD FOR GENERATING A KNOWLEDGE GRAPH FOR TRAFFIC MOTION PREDICTION, METHOD FOR TRAFFIC MOTION PREDICTIONS AND METHOD FOR CONTROLLING AN EGO-VEHICLE

(71) Applicant: Robert Bosch GmbH, Stuttgart (DE)

(72) Inventors: Leon Mlodzian, Düsseldorf (DE); Juergen Luettin, Renningen (DE); Lavdim Halilaj, Leonberg (DE); Zhigang Sun, Zhenjiang City (CN); Hendrik Berkemeyer, Ludwigsburg (DE); Sebastian Monka, Stuttgart (DE); Zixu Wang, Muenchen (DE)

(21) Appl. No.: 18/829,561

(22) Filed: Sep. 10, 2024

(30) Foreign Application Priority Data
Oct. 4, 2023 (DE) 10 2023 209 686.2

(51) Int. Cl. G08G 1/01; G01C 21/00; G08G 1/0967

(52) U.S. Cl. CPC G08G 1/0125; G01C 21/3837; G01C 21/3859; G08G 1/0112; G08G 1/096708

(57) ABSTRACT

A computer-implemented method for generating a knowledge graph for traffic motion prediction. The method includes: receiving environment sensor data of at least one environment sensor of an ego-vehicle; receiving map data from an electronic road map; extracting the information regarding the at least one traffic participant from the environment sensor data and extracting the information regarding the motion track the traffic participant is positioned on from the map data; and generating a knowledge graph of the road network in the environment of the ego-vehicle including nodes and edges based on the map data and/or the environment sensor data. The knowledge graph includes at least one node representing the traffic participant and at least one node representing the lane the traffic participant is positioned on.

### CROSS REFERENCE

The present application claims the benefit under 35 U.S.C. § 119 of German Patent Application No. DE 10 2023 209 686.2 filed on Oct. 4, 2023, which is expressly incorporated herein by reference in its entirety.

### FIELD

The present invention relates to a method for generating a knowledge graph for traffic motion prediction. The present invention further relates to a method for traffic motion prediction. The present invention further relates to a method for controlling an ego-vehicle.

### BACKGROUND INFORMATION

Motion prediction in traffic scenes involves accurately forecasting of the behavior of surrounding traffic participants or other moving objects. Achieving this task intuitively requires considering multiple sources of information, including the driving path of vehicles, road topology, lane dividers, pedestrian crossings, and traffic rules. Although previous studies have demonstrated the potential of leveraging heterogeneous context for improving motion prediction, state-of-the-art deep learning approaches still rely on a limited subset of this information. This is primarily due to the limited availability of comprehensive representations of the contextual information available in prominent datasets.

Traffic motion prediction is a crucial component of autonomous driving, as it enables the autonomous vehicle to anticipate the movement of other traffic participants and avoid dangerous situations that could lead to collisions. Machine learning, in particular deep learning approaches are proven to be very successful for developing motion prediction and often achieving high accuracies. Easily usable datasets have been vital for progress in machine learning. MNIST, COCO and ImageNet were crucial for progress in computer vision, GLUE and

SQUAD for natural language understanding and training environments MuJoCo and OpenAI Gym for reinforcement learning, to list a few. In recent years, however, the limitations of deep learning models have been subject of many investigations.

Specifically, their lack of robustness, explainability as well the inability to generalize to new domains. One hypothesis why modern deep learning models have a lack of robustness is because they are purely sub-symbolic and statistical, learning correlations between input features and target variable instead of gaining a causal, structured understanding of a task.

Humans while driving do not reason at the level of individual pixels but at the level of objects, perceived intentions and spatial and semantic relationships. Humans have inherent prior knowledge at their disposal, for example, the understanding that no traffic participant can have an acceleration above a certain threshold. High-level, structured information (knowledge) is typically missing when deep learning models are trained end-to-end scenarios from raw data. Furthermore, for real-world applications of motion prediction algorithms it is vital to consider safety aspects. ISO 26262, the international standard for the functional safety of road vehicles, needs to be satisfied. It demands that the behavior of components is fully specified and validated.

### SUMMARY

An object of the present invention is to provide an improved method for generating a knowledge graph for traffic motion prediction and an improved method for traffic motion prediction as well as an improved method for controlling an ego-vehicle.

This object may be achieved by methods including certain features of the present invention. Example embodiments of the present invention are disclosed herein.

According to an aspect of the present invention a computer-implemented method for generating a knowledge graph for traffic motion prediction is provided. According to an example embodiment of the present invention, the method comprises:
receiving environment sensor data of at least one environment sensor of an ego-vehicle, wherein the environment sensor data represent the environment of the ego-vehicle and comprise information regarding at least one traffic participant located in the environment of the ego-vehicle;
receiving map data from an electronic road map, wherein the map data represent a road network in the environment of the ego-vehicle and comprise information regarding at least one motion track the traffic participant is positioned on;
extracting the information regarding the at least one traffic participant from the environment sensor data and extracting the information regarding the road and/or lane the traffic participant is positioned on from the map data; and
generating a knowledge graph of the road network in the environment of the ego-vehicle comprising nodes and edges based on the map data and/or the environment sensor data, wherein the knowledge graph comprises at least one node representing the traffic participant and at least one node representing the lane the traffic participant is positioned on.

Hereby, a technical advantage can be achieved, that an improved method for generating a knowledge graph for a traffic motion prediction can be provided. For this, environment sensor data of at least one environment sensor of an ego-vehicle are considered as information for the knowledge graph. The environment sensor data represent the environment of the ego-vehicle and comprise information regarding at least one traffic participant located in the environment of the ego-vehicle. Via the environment sensor data information regarding this at least one traffic participant located in the environment of the ego-vehicle can be extracted.

Further, map data from an electronic road map representing a road network in the environment of the ego-vehicle are also received. Via the map data information regarding at least one motion track of the traffic participant positioned in the environment of the ego-vehicle can be extracted.

Via the environment sensor data information regarding individual features of the traffic participant can be considered for the generation of the knowledge graph. Via the map data of the electronic road map information regarding features of the motion track of the traffic participant it can be considered in the generation of the knowledge graph.

During generation of the knowledge graph the information extracted from the environment sensor data and the information extracted from the map data are included into the knowledge graph by means of nodes and/or edges of the knowledge graph.

As a result, a knowledge graph can be generated, comprising information regarding individual features of the traffic participants located in the environment of the ego-vehicle and information regarding individual features of the motion tracks of those traffic participants. This allows for generation of a knowledge graph with precise information regarding traffic participants and respective motion tracks of these traffic participants located in the environment of the ego-vehicle.

Based on this knowledge graph a precise and reliable traffic motion prediction of future motion of traffic participants located in the environment of the ego-vehicle is possible.

In the sense of the present application, the motion track of the traffic participants is defined as a distinguishable area in the road network. The motion track is a piece of the infrastructure within the environment of the ego-vehicle on which the respective traffic participant is located and which enables the traffic participant for a future motion.

According to an example embodiment of the present invention, the motion track the traffic participant is located on is at least one out of the following list: road and/or lane, intersection, underpass, bridge, motorway, motorway access, motorway exit, roundabout, parking bay, parking lot, bicycle lane, tramway track, pedestrian crossing, sidewalk.

Hereby, a technical advantage can be achieved that a variety of different motion tracks for different traffic participants located in the environment of the ego-vehicle can be considered for the generation of the knowledge graph. This way, a knowledge graph can be generated for a large variety of different traffic participants located in different location within the environment of the ego-vehicle. This allows for a precise and flexible traffic motion prediction based on a respective knowledge graph that is applicable to many different traffic scenarios.

According to an example embodiment of the present invention, the map data of the electronic road map comprise further information regarding further features of the motion track the traffic participant is located on, and wherein the at least one further feature of the motion track of the traffic participant is integrated into the knowledge graph via at least one further node.

Hereby, a technical advantage can be achieved that via the further features of the motion track of the traffic participants additional information regarding the motion track can be introduced into the knowledge graph. This additional information regarding the motion track allows for a more precise traffic motion prediction based on a respective knowledge graph.

According to an example embodiment of the present invention, the environment sensor data further comprise further information regarding at least one further feature of the traffic participant, and wherein the at least one further feature of the traffic participant is integrated into the knowledge graph via at least one further node.

Hereby, a technical advantage can be achieved that further information regarding additional individual features of the traffic participants can be introduced into the knowledge graph. Due to this further information a more precise description of the traffic participant can be introduced into the knowledge graph. As a result, a more precise motion prediction of future motion of the respective traffic participant can be achieved based on the respective knowledge graph.

According to an example embodiment of the present invention, the nodes and further nodes of the knowledge graph are organized in classes and sub-classes.

Hereby, a technical advantage can be achieved that through the organization into classes and subclasses of the nodes of the knowledge graph in organization of the information within the knowledge graph is achieved.

According to an example embodiment of the present invention, the further features of the motion track are at least one of the following list comprising: road geometries, lane geometries, lane dividers, lane boundaries, lane connectors, intersections, stop areas, traffic signals, traffic signs, traffic regulations, road conditions, slope values, pedestrian crossings, car park areas, road segments, road blocks.

Hereby, a technical advantage can be achieved that the knowledge graph can be generated for multiple different traffic participants positioned in multiple different motion tracks located in the environment of the ego-vehicle. This allows for a flexible and probably applicable traffic motion prediction based on a respective knowledge graph.

According to an example embodiment of the present invention, the further features of the traffic participant are at least one of the following list comprising: static object, moving object, human, animal, vehicle, car, truck, tram, motorcycle, bicycle, barrier, traffic cone, a relative position to at least one further traffic participant and/or to the ego-vehicle.

Hereby, a technical advantage can be achieved that a variety of different types of traffic participants can be considered for the generation of the respective knowledge graph. This allows for a broadly applicable traffic motion prediction based on a respective knowledge graph.

According to an example embodiment of the present invention, the method further comprises:
determining a time stamp of the environment sensor data and of the map data;
organizing the environment sensor data and the map data in scenes and sequences, wherein a scene comprises the information of the environment sensor data and the map data for one time stamp, and wherein a sequence is a series of successive scenes; and
organizing the nodes of the knowledge graph with respect to the scenes and sequences of the environment sensor data and the map data.

Hereby, a technical advantage can be achieved that due to the organization of the nodes of the knowledge graph would respect to scenes and sequences of the environment sensor data and the map data, a time instance can be introduced into the knowledge graph. This allows for a usage of the knowledge graph for traffic motion prediction based on time depended data, as they occur on constantly changing traffic scenarios present during the operation of the ego-vehicle. As a result, the respective knowledge graph can be used for traffic motion prediction and it can be applied during the operation of the ego-vehicle.

According to an example embodiment of the present invention, the information of the map data considered in generating the knowledge graph is limited to an area of a possible path of the traffic participant.

Hereby, the technical advantage can be achieved that the knowledge graph can be reduced in size and reduced to the information essential to the traffic motion prediction. This allows for a fast and efficient traffic motion prediction.

According to an example embodiment of the present invention, the method is executed during a driving operation of the ego-vehicle.

Hereby, the technical advantage can be achieved that the knowledge graph can be generated and updated during operation of the ego-vehicle. This allows for a precise traffic motion prediction.

According to an aspect of the present invention, a computer-implemented method for traffic motion prediction is provided. According to an example embodiment of the present invention, the method comprises:
Generating a knowledge graph for traffic motion prediction by executing the method for generating a knowledge graph for traffic motion prediction according to any of the previous embodiments; and
Predicting a future motion of at least one traffic participant positioned in an environment of an ego-vehicle based on the knowledge graph by a motion prediction module.

Hereby, a technical advantage can be achieved that an improved method for traffic motion prediction can be provided. The method for controlling the ego-vehicle uses the method for generating a knowledge graph for traffic motion prediction with the above mentioned technical advantages.

According to an example embodiment of the present invention, the motion prediction module comprises a trained artificial intelligence capable of predicting the motion of the traffic participant based on information of the knowledge graph.

Hereby, a technical advantage can be achieved that a robust and efficient prediction module can be provided.

According to an example embodiment of the present invention, the artificial intelligence comprises a graph neural network.

Hereby, a technical advantage can be achieved that a robust and efficient prediction module can be provided.

According to an aspect of the present invention, a computer-implemented method for controlling an ego-vehicle is provided. According to an example embodiment of the present invention, the method comprises:
Predicting a future motion of at least one traffic participant located in an environment of the ego-vehicle by executing the method for traffic motion prediction according to any of the previous embodiments; and
Executing at least one control function of the ego-vehicle based on the predicted motion of the at least one traffic participant.

Hereby, ae technical advantage can be achieved that an improved method for controlling an ego-vehicle can be provided. The method for controlling the ego-vehicle uses the method for traffic motion prediction with the above mentioned technical advantages.

According to an aspect of the present invention, a computing unit equipped to carry out the method for generating a knowledge graph for traffic motion prediction according to any of the above-described embodiments and/or the method for traffic motion prediction according to any of the above-described embodiments and/or the method for controlling an ego-vehicle is provided.

According to an aspect of the present invention, a computer program product is provided comprising instructions that, when the program is executed by a data processing unit, cause the data processing unit to execute the method for generating a knowledge graph for traffic motion prediction according to any of the above-described embodiments and/or the method for traffic motion prediction according to any of the above-described embodiments and/or the method for controlling an ego-vehicle.

Example embodiments of the present invention will be described about the following figures.

### BRIEF DESCRIPTION OF THE DRAWINGS

FIGS. 1A and 1B show a schematic illustration of a system for generating a knowledge graph for traffic motion prediction according to an example embodiment of the present invention.

FIG. 2 shows a further schematic illustration of a system for generating a knowledge graph for traffic motion prediction according to a further example embodiment of the present invention.

FIGS. 3A and 3B show a further schematic illustration of a system for generating a knowledge graph for traffic motion prediction according to a further example embodiment of the present invention.

FIG. 4 shows a schematic illustration of a knowledge graph for traffic motion prediction according to an example embodiment of the present invention.

FIG. 5 shows a flow chart of a method for generating a knowledge graph for traffic motion prediction according to an example embodiment of the present invention.

FIG. 6 shows a flow chart of a method for traffic motion prediction according to an example embodiment of the present invention.

FIG. 7 shows a flow chart of a method for controlling an ego-vehicle according to an example embodiment of the present invention.

FIG. 8 shows a schematic illustration of computer program product, according to an example embodiment of the present invention.

### DETAILED DESCRIPTION OF EXAMPLE EMBODIMENTS

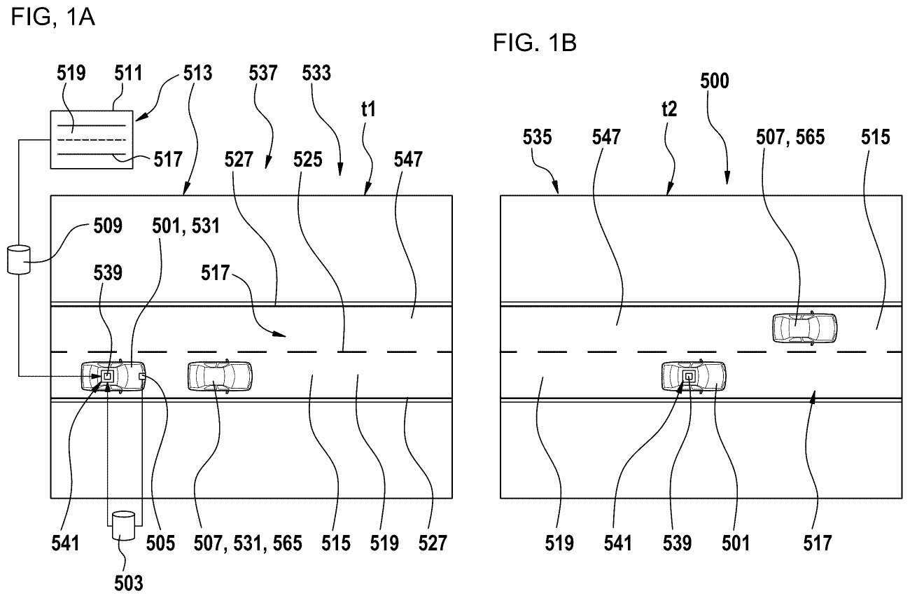

FIGS. 1A and 1B show a schematic illustration of a system 500 for generating a knowledge graph 400 for traffic motion prediction according to an embodiment.

FIGS. 1A and 1B show two traffic scenarios represented in a first scene 533 and a second scene 535 illustrated in the FIG. 1A and FIG. 1B, respectively. The first and second scenes 533, 535 possess a time stamp t1, t2, at which the respective traffic scenarios were observed.

In the two traffic scenarios an ego-vehicle 501 is shown driving on a road 517 comprising a first lane 519 and a second lane 547. In the two shown traffic scenarios a further traffic participant 507 is positioned in an environment of the ego-vehicle 501. In the shown embodiment the further traffic participant 507 is a vehicle 565 in particular a car 531. The traffic participant 507 is moving on a motion track 515.

The motion track 515 is defined by a piece of infrastructure in the environment of the ego-vehicle is positioned on that allows for a future movement of the traffic participant 507. In the shown example the motion track 515 is given by the road 517 and in particular by one of the lanes 519, 547.

In the two scenes 533, 535 a driving scenario of the ego-vehicle 501 and the further traffic participant 507 is shown.

The two scenes 533, 535 describe two successive traffic scenarios, wherein from scene 533 to scene 535 the traffic participant 507 performs a lane change maneuver and changes its position from the first lane 519 to the second lane 547. The two shown traffic scenarios are just an example and should not limit the scope of the current invention.

In the shown embodiment the ego-vehicle 501 comprises a computing unit 541 and at least one environment sensor 505. Via the environment sensor 505 the ego-vehicle 501 can collect environment sensor data 503 representing the environment of the ego-vehicle 501. The environment sensor 505 can for example be a camera sensor, an ultrasonic sensor, a radar sensor or any environment sensor from the field of automated driving. Based on the environment sensor data 503 the ego-vehicle 501 is capable of the detecting the further traffic participants of 507 located in the environment of the ego-vehicle 501.

Further, the ego-vehicle 501 has access to an electronic road map 511. The electronic road map 511 represents a road network 513 with a multiplicity of road, lanes and other features of the traffic infrastructure and provides detailed information regarding the roads, lanes and the infrastructure in the environment of the ego-vehicle 501.

By use of the computing unit 541, the map data 509 and the environment sensor data 503 the ego-vehicle is capable of executing the method for generation a knowledge graph for traffic motion prediction according to the current invention.

For this, the ego-vehicle 501 detects the traffic participant 507 in the environment of the ego-vehicle 501 and the respective motion track 515 via the environment sensor data 503.

Via the map data 509 of the electronic road map 511 further information regarding the detected and/or identified motion track 514 of the traffic participant 507 are received.

Based on the environment sensor data 503 and the map data 509 the motion track 514 of the traffic participant 507 can be for example identified as a road 517 and or a lane 519, 547, an intersection, an under path, a bridge, a motorway access, a motorway exit, a roundabout, a parking bay, a parking lot.

Based on the environment sensor data the traffic participant 507 can further be identified as a static object, a moving object, a human, an animal, a vehicle 565, a car 531, a truck, a tram, a motorcycle, a bicycle, a barrier or a traffic cone.

On the respective type of the traffic participant 507 the motion track 515 can further be identified as a bicycle lane, a tramway track, a pedestrian crossing or a sidewalk or any other possible motion track 515.

From the map data 509 further individual information regarding the previously identified motion track 515 can be considered. The further features can comprise road geometries, lane geometries, lane dividers 525, lane boundaries 527, lane connectors, intersections, stop areas, traffic signals, traffic signs, traffic regulations, road conditions, slope values, pedestrian crossings, car park areas, road segments, road blocks or any other features presenting the infrastructure of a traffic scenario.

To generate the knowledge graph based on the information from the map data 509 and the environment sensor data 503 an extraction of the above-named information regarding the motion track 515 and the participant track 507 from the environment sensor data 503 and the map data 509 are extracted.

Based on this extracted information regarding the motion track 515 and the traffic participant 507 the knowledge graph is generated, wherein said extracted information is included into the knowledge graph via multiple nodes and edges connecting said nodes.

According to an embodiment of the present invention the respective knowledge graph is organized in the above-mentioned scenes 533, 535, each describing subsequent traffic scenarios taking place in different time stamps t1, t2. This way, the knowledge graph is organized in a time depending pression, wherein for each scene 533, 535 and the respective time stamp t1, t2 the above-mentioned information is included into the knowledge graph with respective nodes and edges.

In FIGS. 1A and 1B, the two illustrated scenes 533, 535 define a sequence 537. The sequence 537 describes the sequential dependence of the illustrated scenes 533, 535. The sequence information can also be included into the knowledge graph as additional information.

In FIGS. 1A and 1B, additional to the road 517 and the lanes 519, 547, lane dividers 525 and lane boundaries 527 are shown.

In the shown embodiment the ego-vehicle 501 further comprises a motion prediction module 539 installed on the computing unit 541. Via the motion prediction unit 531 the ego-vehicle 501 is capable of executing the method for traffic motion prediction according to the current invention.

For executing the traffic motion prediction, during operation the ego-vehicle 501 collects the environment sensor data 503 in order to detect and identify the traffic participant 507 and the respective motion tracks 515 of the traffic participant 507 located in the environment of the ego-vehicle 501.

Further, the information regarding the road network 513 within the environment of the ego-vehicle 501 is extracted from the map data 509 of the electronic road map 511. Based on the information extracted from the map data 509 and the environment sensor data 503 the ego-vehicle 501 generates the above-mentioned knowledge graph. This generation of the knowledge graph can be executed during operation mode, in particular driving mode, of the ego-vehicle 501.

Based on the information of the knowledge graph the traffic prediction module 539 is capable of predicting a future motion of the traffic participants 507 positioned and identified within the environment of the ego-vehicle 501. For this, the traffic prediction module 539 it can be designed as a trained artificial intelligence capable of performing motion prediction based on the information of the above-mentioned knowledge graph. For this, the motion prediction module 539 can be designed as a graph network, capable of performing said motion prediction.

Via the computing unit 541 the ego-vehicle 501 is further capable or executing the method for controlling the ego-vehicle 501 according to the current invention. For this, the ego-vehicle 501 first executes the method for traffic motion prediction and predicts a future motion of the further traffic participants 507 located and identified within the environment of the ego-vehicle 501. Based on the predicted future motion of the identified traffic participants 507 the ego-vehicle 501 executes at least one control function. The control function can for example be an acceleration or deceleration and/or a steering function.

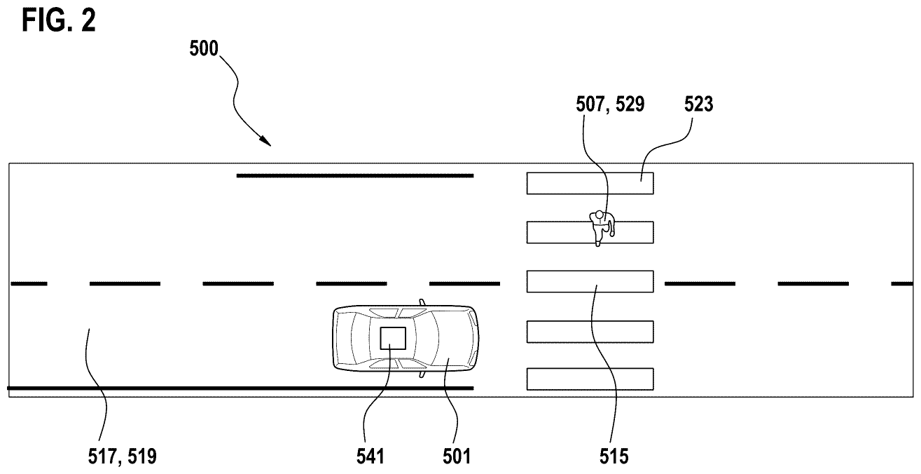

FIG. 2 shows a further schematic illustration of a system 500 for generating a knowledge 400 graph for traffic motion prediction according to a further embodiment.

FIG. 2 shows a different traffic scenario as another example on the current invention. In the shown traffic scenario, a further traffic participant 507 is located in the environment of the ego-vehicle 501. In the current scenario the further traffic participant 507 is a human 529. The human 529 is moving on its motion track 515. The motion track 515 in the current example is a pedestrian crossing 523 intersecting the lane 519 of the road 517 the ego-vehicle 501 is positioned on. Except the mentioned differences, the shown embodiment in FIG. 2 is based on the embodiment of FIG. 1 and comprises all features shown in FIG. 1.

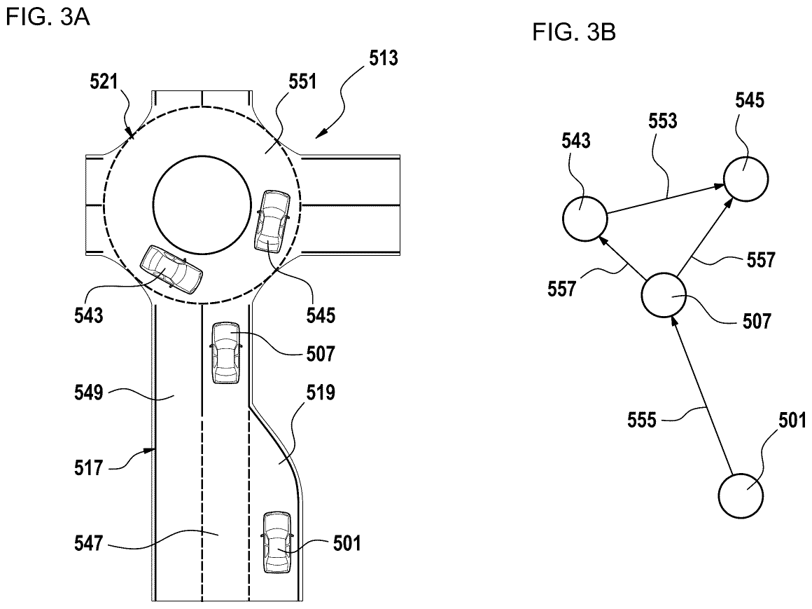

FIGS. 3A and 3B show a further schematic illustration of a system 500 for generating a knowledge graph 400 for traffic motion prediction according to a further embodiment.

FIG. 3A shows another traffic scenario. FIG. 3B shows a schematic illustration of the same traffic scenario. In the shown traffic scenario, the ego-vehicle 501 is positioned on a first lane 519. The traffic participant 507 is positioned on a second lane 547. Further, a first further traffic participant 543 and a second further traffic participant 545 are positioned on a fourth lane 551 of a roundabout 521.

In the shown traffic scenario, the first and second further traffic participants 543, 545 are positioned on the same lane 551 and therefor have a longitudinal relative position 553 to each other.

The ego-vehicle 501 and the traffic participant 507 are positioned on different lanes that are oriented parallel to each other. The ego-vehicle 501 and the traffic participant 507 therefore have a transversal relative position 555 to each other.

The second lane 547, on which the traffic participant 507 is positioned, and the fourth lane 551 of the roundabout 521, on which the first and second further traffic participants 543, 545 are positioned, are intersecting each other. Therefore, the traffic participant 507 and the first and second further traffic participants 543, 545 have an intersecting relative position 557.

In FIG. 3B, the relative positions of the ego-vehicle 501, the traffic participant 507 and the first and second further traffic participants 543, 545 are illustrated in a schematic way.

According to a further embodiment of the current invention the further information regarding the traffic participant 507, or the multiple traffic participants 507, 543, 545, positioned in the environment of the ego-vehicle 501 can include the above-mentioned relative positions relative to each other and relative to the ego-vehicle 501.

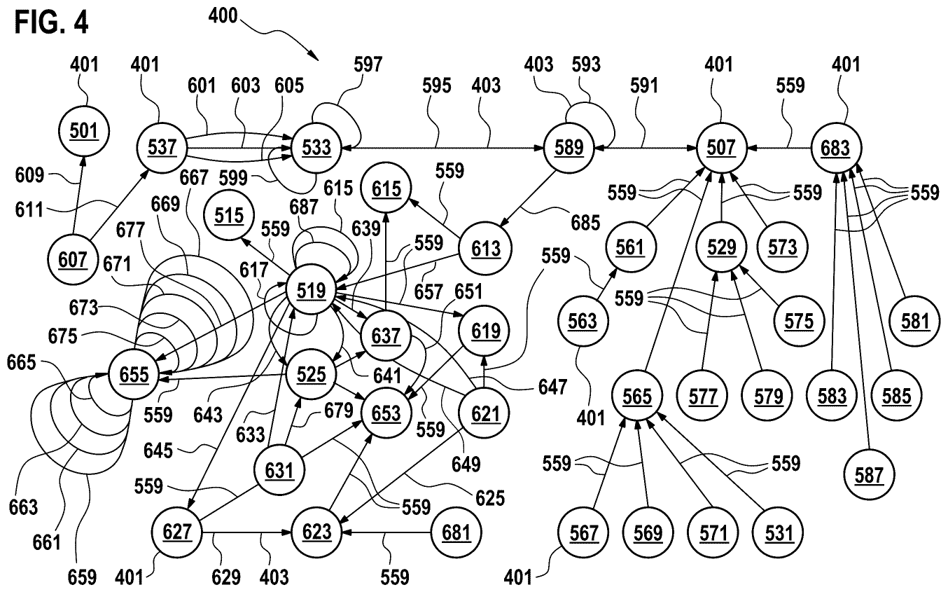

FIG. 4 shows a schematic illustration of a knowledge graph 400 for traffic motion prediction according to an embodiment.

The knowledge graph 400 comprises multiple nodes of 401 and edges 403 connecting the nodes of 401.

On the right side of FIG. 4 the information regarding the traffic participants 507 are illustrated with respective nodes of 401. On the left side of FIG. 4 the information regarding the motion track 515 of the traffic participant 507 are considered with respective nodes and edges 401, 403.

On the right side the traffic participant 507 is represented with a node 401. To the node of the traffic participant 507 multiple further nodes are connected. Via these further nodes the traffic participants 507 can be characterized more precisely.

For example, the traffic participant 507 can be characterized as a static object 561 or a movable object 583. Both objects 561, 583 are included into the knowledge graph 400 via an individual node 401. The static object 561 can for example be a bicycle rack 563. The movable objects 683 can for example be a barrier 583, a pushable/pullable object 585, a traffic cone 587, a debris 581. Each of the object types are provided with a respective individual node 401.

In addition to the static object 561 or the movable object 683 the traffic participant 507 can further be a vehicle 565. The vehicle 565 can be a bicycle 567, a motorcycle 569, a truck 571 or a car 531. Each of the vehicle types are provided with respective nodes 401 and are connected via respective edges to the node of the vehicle 565.

In addition to the vehicle 565 the traffic participant 507 can further be an animal 573 or a human 529. The human 529 can be a police officer 575, an adult 577 or a child 579.

All nodes 401 on the right side of the knowledge graph 400 are characterizations of the traffic participants 507 and are organized as subclasses 559. Thus, the respective nodes 401 are connected via subclass relations 559 to the respective nodes 401 of the main classes and/or the traffic participant 507.

The knowledge graph 400 is organized in a first scene 533. All shown nodes of 401 are organized with one respective scene 533. For multiple scenes 533, 535 the knowledge graph 400 can comprise multiple layers of the nodes 401 shown in FIG. 4. Each layer describes an individual scene 533, 535 and is connected to a layer representing a previous and/or subsequent scene 533, 535.

This connection of the scene 533 to previous and/or subsequent scenes is illustrated in the knowledge graph 400 via a hasPreviousScene relation 599 and to a next scene via a hasNextScene relation 597.

The previous and next scenes related to the respective time stamps t1, t2 at which the respective map data 509 and environment sensor data 503 has been connected.

The scene 533 is part of a sequence 537 and is connected to the respective node 401 of the sequence 537 via a hasFirstScene relation 601, a hasLastScene relation 603 and a hasScene relation 605.

The sequence 537 represents a multiplicity of subsequential scenes 533. The sequence 537 is a part of a Trip 607. The Trip 607 comprises a multiplicity of sequential sequences 537 and is connected to the node of the sequence 537 via a hasSequence relation 611.

The Trip 607 is connected to the node 401 of the ego-vehicle 501 via a hasEgoVehicle relation 609.

The node 401 of the scene 533 is further connected to the node of a scene participant 589 via a hasSceneParticipant relation 595. The scene participant 589 is further connected to the traffic participant 507 via a isSceneParticipant relation 591.

A scene participant describes a traffic participant 507 of a particular scene 533, 535. With regard to the respective traffic scenarios the number of traffic participants 507 positioned

The scene participant 589 is further connected to itself in a nextScene via a nextScene relation 593. The scene participant 589 is further connected to point 613 via a hasPosition relations 685. This can describe a particular position of the scene participant 589.

The point 613 is connected to a node 401 of a geometry 635 via a subclass relation 559. The point 613 is further connected to a lane 519 via a isPointOnLane relation 657. The lane 519 is connected to the node 401 of a motion track 515 via a subclass relation 559.

The lane 519 is further connected to a next lane via a hasNextLane relation 617. The lane 519 can further be a right lane or a left lane and therefore comprises a hasLeftLane relation 687 and a hasRightLane relation 615.

The lane 519 can further be a subclass of a road traversal element 619 and therefore be connected to the respective node 401 of the road traversal element 619 via a subclass relation 559.

The lane 519 is further connected to a road block 627 via a IsLaneOnRoadBlock relation 645. The road block 627 is connect to the road element 653 via a subclass relation 559.

The road block 627 is further connected to a road segment 623 via a isRoadBlockOnRoadSegment relation 629.

The road segment 623 is further connected to the lane connector 621 via a isConnectorOnRoadSegment relation 625. The road segment 623 is further connected to an intersection 681 via a subclass relation 559.

The lane connector 621 is further connected to the lane 519 via a ConnectsIncomingLane relation 647 and a ConnectsOutgoingLane relation 649.

The lane 519 is further connected to a car park area 631 via a CarparkAreaIsNextTo relation 633.

The carpark area 631 is further connected to a lane divider via a carparkAreahasShape relation 679.

The lane 519 is further connected to a polygon 637 via a LaneHasShape relation 639.

The lane 519 is further connected to the lane divider 525 via hasRightLaneDivider relation 641 and hasLeftLaneDivider relation 643.

The road element 653 further has an isPartOf relation 651. Further, the road element 653 is connected to a lane snippet 655 via a subclass relation 559.

The lane snippet 655 further has a SwitchViaSingleSolidYellow relation 659, a SwitchViaRoadDivider relation 661, a SwitchViaDoubleSolidYellow relation 663, switchVia relation 665, a SwitchViaSingleZigZagWhite 667, a SwitchViaSingleWhite relation 669, a SwitchViaNonVisible relation 671, a SwitchViaDoubleDashedWhite relation 673 and is connected to a next lane snippet via a hasNextLaneSnipped relation 675.

The lane snippet 655 is further connected to the lane 519 via a hasLaneSnipped relation 677.

The embodiment shown in FIG. 4 is just an example of a possible knowledge graph 400 for traffic motion prediction. According to the current invention the knowledge graph 400 comprises at least information regarding one traffic participant 507 positioned in the environment of the ego-vehicle 501 and information regarding the motion track 515 of that particular traffic participant 507. The respective information is included into the knowledge graph 400 via multiple nodes 401 and edges 403.

As explained above, the structure of the knowledge graph 400, in particular the information stored in the nodes 401 and the respective relations between the nodes 401 depends on the respective traffic scenario, the number of traffic participants 507 located in the environment of the ego-vehicle 501 and the information accessible via the environment sensor data 503 and the map data 509.

In the present invention the concepts Sequence 537 and Scene 533, 535 are used. A detailed description of the concepts Sequence 537 and Scene 533, 535 is provided in Lavdim Halilaj, Jürgen Luettin, Cory Andrew Henson, Sebastian Monka, “Knowledge graphs for automated driving,” 2022 IEEE Fifth International Conference on Artificial and Knowledge Engineering (AIKE), pages 98-105, 2022.

In short, a Scene 533, 535 refers to a single moment in a traffic situation. The relation hasTimestamp is an integer data property with a unix timestamp defining a specific moment in time.

A Sequence 537 is an ordered collection of Scenes 533, 535. A Sequence 537 can be thought of as a video where its frames are Scenes 533, 535. Since the order of Scenes 533, 535 is inherent in them, object properties hasNextScene 597 and hasPreviousScene 599 are defined to link consecutive Scenes 533, 535. The Sequence 537 and Scene 533, 535 instances can be generated from the map data 509 of the electronic road map 511. The map 511 can be based on the nuScenes date set.

Equations (1) to (22) are formulated in the formalism of description logic. A detailed explanation of the formalism can be found in Krötzsch et al. arXiv:1201.4089

Equation (1) provides a definition of the Scene 533, 535 and Sequence 537. Scene 533, 535 and Sequence 537 both are nodes 401 in the knowledge graph 400.

$$Scene ≡ ∃ hasNextScene \cdot Scene ⋃ ∃ hasPreviousScene \cdot Scene \qquad ( 1 )$$

$$Sequence ≡ ∃ hasScene \cdot Scene \qquad ( 2 )$$

Sequences 537 refer to specific motion prediction situations. During recording of motion data, the ego-vehicle might travel for hours and record several Sequences 537.

A Trip 607 is such a recording session and each of its entities points to several Sequences 537. Each Trip 607 is taken in a particular region of interest, a Location, related to it via hasLocation. hasRightHandTraffic is a Boolean property to describe the driving direction at a Location.

Equations (3), (4) provide a definition of the concepts Trip 607 and Location.

$$Trip ≡ ∃ hasSequence \cdot Sequence \qquad ( 3 )$$

$$Location ≡ ∃ {hasLocation}^{- 1} \cdot Trip \qquad ( 4 )$$

Trip 607 instances can be generated from the map data 509, for example the nuScenes LOG records, and a Location instance can be manually created for each of the four maps.

The traffic participant 507 concept represents a traffic agent present in one or multiple Scenes 533, 535. The various types of participants are modelled as subclasses of the Participant concept. There are in total 23 different ones.

Examples are cars, adults, children, police officers, ambulances, bicycles and so on. Participants can refer to an entity at a certain timestep. A new relation inNextScene was introduced to be able to link entities across time.

Further, the concept SceneParticipant was introduced as a notion of an agent at a certain timestep and the meaning of traffic participant 507 was changed to represent an agent generally, independent of time.

This avoids having to store time-independent information, e.g., sizes of agents, redundantly. The semantic relationship between SceneParticipants can be modelled, such that agents may follow one another, potentially intersect or be parallel to one another.

$$Equations ( 5 ) , ( 6 ) provide a definition of the concepts SceneParticipant and Participant .$$

$$SceneParticipant ≡ ∃ {hasSceneParticipant}^{- 1} \cdot Scene ⋂ ∃ isSceneParticipantOf \cdot Participant \qquad ( 5 )$$

$$Participant ≡ ∃ {isSceneParticipantOf}^{- 1} \cdot SceneParticipant \qquad ( 6 )$$

SceneParticipant instances are generated from SAMPLE ANNOTATION and EGO_POSE records. The EGO_POSE records are needed such that the ego-vehicle can be included as a SceneParticipant. This is a novelty in the provided data representation. Previous work has ignored the effect of the ego-vehicle 501 on the target vehicle's motion.

The currently provided data analysis of the nuScenes dataset shows that the ego-vehicle 501 and target can be up to 2 m close in a significant number of cases. Therefore, the ego-vehicle 501 is considered to have a high influence on the target vehicle's behavior.

The central component of road traffic infrastructure is the lane 519, 547, 549, 551. This is defined as a non-overlapping stretch of road surface, typically confined by lane borders, where only one driving direction is allowed. This is a natural, physical lane formalization since one would not consider intersections or merge points part of one particular lane 519, 547, 549, 551.

A different modelling option would have been to use a definition that treats lane 519, 547, 549, 551s not as physical, but logical entities which can overlap. Such lanes 519, 547, 549, 551 would go across junctions. We chose the natural, physical definition for compatibility with nuScenes. To keep the logical connectivity information with the natural definition, one needs LaneConnectors, which have the functional properties hasIncomingLane and hasOutgoingLane pointing to a Lane each.

Equations (7), (8) provide a definition of the concepts Lane and LaneConnector.

$$Lane ≡ ∃ hasNextLine \cdot Line ⋃ ∃ hasPreviousLane \cdot Lane ⋃ ∃ hasLeftLane \cdot Lane ⋃ ∃ hasRightLane \cdot Lane \qquad ( 7 )$$

$$( 8 )$$

$$LaneConnector ≡ ∃ hasIncomingLane \cdot Lane ⋂ ∃ hasOutgoingLane \cdot Lane$$

Lane and LaneConnector instances are generated from LANE and LANE CONNECTOR records, respectively. LaneSnippet, switchVia.

Lane borders are another crucial element determining how cars travel.

Different lane divider types exist, such as solid lines and dashed lines. A LaneSnippet is defined as a piece of a lane 519, 547, 549, 551 that has a single border type on each its left and its right side. This allows the introduction of a switchVia property for every type of border, i.e., switchViaDoubleDashed, switchViaSingleSolid, etc. Neighboring snippets that have a, say, single solid border between them, get related to one another via switchViaSingleSolid, representing that a single solid border would have to be crossed to switch from one to the other.

Switches via borders that are illegal are kept in the model because cars may sometimes break traffic rules and overtake across a solid border, for example. hasNextLaneSnippet points from one snippet to the immediately following one, keeping them ordered and hasLaneSnippet keeps them connected to their parent Lane 519, 547, 549, 551.

Further, since experimental evidence has shown that it is important for trajectory prediction performance to keep snippets short, they are further divided if they exceed 20 meters in length. snippetHasLength keeps a record of how long a particular lane snippet is.

Equation (9) provides a definition of the concept LaneSnippet.

$$LaneSnippet ≡ ∃ switchViaDoubleDashed \cdot LaneSnippet \text{} switchViaSingleSolid \cdot LaneSnippet ⋃ \qquad ( 9 )$$

LaneSnippet instances were computed from LANE records. The border types (solid line, dashed line, etc.) on each side of a lane were tracked and split into sections that have non-changing border types on either side. Sections were divided, if necessary, to satisfy the 20 m length bound. This produced LaneSnippet instances with constant border types on either side. switchVia edges were placed between neighbouring LaneSnippet instances.

To represent the centerlines (where cars typically drive) of lanes and lane connectors, a sequence of Poses is used. A Pose consists of a position and an orientation. The orientation here denotes the orientation of the lane, i.e., the traffic direction, at a certain position. An OrderedPose is a subclass of Pose that also has the textithasNextPose property.

This is used to order them, defining the typical trajectory along a LaneConnector via the connectorHasPose relation to all its ordered poses. A Pose's position, is modelled with sf: Point as are the agent positions, and its orientation with data property poseHasOrientation, represented as the angle between the positive x-axis and the direction facing (yaw). Contrary to lane connectors, the lane model needs to satisfy competency questions about width, too.

The natural naming LaneSlice is chosen to represent the combination of center pose and lane width. hasNextLaneSlice keeps them ordered by connecting consecutive slices, hasLaneSlice points from parent lane to its slices and laneSliceHasWidth is the data property the name suggests

Equations (10), (11), (12) provide a definition of the concepts LaneSlice and OrderedPose.

$$LaneSlice ≡ ∃ {laneHasSlice}^{- 1} \cdot Lane ⋂ ∃ laneSliceHasWidth \cdot R \qquad ( 10 )$$

$$OrderedPose ≡ ∃ {connectorHasPose}^{- 1} \cdot LaneConnector \qquad ( 11 )$$

$$OrderedPose ⊑ Pose \qquad ( 12 )$$

OrderedPose instances were generated from the hand-annotated arclines from nuScenes at a resolution of 2 m with the aid of the nuscenes-devkit. LaneSlice instances additionally represent lane width.

A given center point, for which width is to be computed, is projected to both left and right borders. The projected points are those points on the borders that have the smallest Euclidean distance to the given center point. The width is given by the distance between the projected points. StopArea.

Stop areas are a very important concept for motion prediction because they, by definition, are the regions where cars tend to come to a halt. Several reasons exist for such regions and each is modelled as a subclass of the parent class StopArea. These include stop signs, yield signs, oncoming traffic when wanting to make a left turn, pedestrian crossings, and traffic lights. causesStopAt link the causing entity to their associated StopArea.

Equation (13) provides a definition of the concept StopArea.

$$StopArea ≡ PedCrossingStopArea ⋃ TrafficLightStopArea ⋃ YieldStopArea ⋃ StopSignArea ⋃ TurnStopArea \qquad ( 13 )$$

StopArea instances were generated from nuScenes STOP LINE records.

TrafficLight. Their physical appearance is represented with categorical data property hasTrafficLightType, differentiating between horizontally and vertically stacked lights. In addition, the lights are at a certain position and face a certain way, which is represented via trafficLightHasPose pointing to a particular Pose instance. The dynamic state of traffic lights (light color) is not modelled because this information is not available in the nuScenes dataset.

Equation (14) provides a definition of the concept TrafficLight.

$$TrafficLight ≡ ∃ trafficLightHasPose \cdot Pose ⋂ ∃ hasTrafficLightType \cdot \{ H , V \} \qquad ( 14 )$$

TrafficLight instances were generated from nuScenes TRAFFIC LIGHT records.

PedCrossing. This is where pedestrians can legally cross the road. The two walkways connected via a crossing are represented with the connectsWalkways relation.

Equation (15) provides a definition of the concept PedCrossing.

$$PedCrossing \text{≡≤} 2 connectsWalkways \cdot Walkway \qquad ( 15 )$$

Inspection by eye of several pedestrian crossings and walkways in the nuScenes dataset showed that they do not necessarily touch, but they are always in proximity.

As a heuristic, walkways within 5 m of a crossing were considered. Our algorithm chooses the two walkways with minimal distances. To check implementation correctness, a subset of generated triples was visualized and manually verified. Walkway, CarparkArea.

Walkways are modelled with a concept of the same name. CarparkArea is any area where cars can park, be that on an actual carpark or by the side of a road. To represent proximity between neighboring parts of the road explicitly, isNextTo exist. carparkAreaIsNextTo represents which lane a carpark is next to and analogously walkwayIsNextTo represents neighbouring between walkways and lanes.

Equations (16), (17) provide a definition of the concepts WalkWay and CarparkArea.

$$Walkway ≡ ∃ walkwayIsNextTo \cdot Lane \qquad ( 16 )$$

$$CarparkArea ≡ ∃ carparkIsNextTo \cdot Lane \qquad ( 17 )$$

The isNextTo relation between walkways, lanes and carparks is generated for those pairs of entities that are within 4 m.

This heuristic threshold was chosen after visualizing several lanes, carparks and walkways and their proximities. This way an explicit spatial relation is established between neighboring pavement surfaces. Road blocks 627 group adjacent lanes that go in the same direction. A hasNextRoadBlock edge exists from one block to another, if they contain lanes that follow one another.

Road block 627 connectivity therefore models any potential future region a car can go, considering possible lane switches, which lane connectivity does not. Further, a hasOpposingRoadBlock relation is introduced. It exists between two road blocks 627 if they are parallel to each other on the same road, carrying traffic in opposite directions. This extends the spatial connectivity in the graph like the isNextTo property, making spatial relations explicit that humans see intuitively.

Equation (18) provides a definition of the concept RoadBlock.

$$RoadBlock ≡ ∃ hasNextRoadBlock \cdot RoadBlock \qquad ( 18 )$$

RoadBlock instances were computed by grouping neighboring Lanes and the connectivity between road blocks 627 was dictated by the lane connectivity. Instances could not be generated from nuScenes ROAD BLOCK 627 records because they contained malformed shapes on two of the four maps, as was raised in a GitHub issue. Intersection. This is where multiple lanes intersect.

The typical paths traversed over intersections are characterized by lane connectors across it. A lane 519, 547, 549, 551 going into the intersection with a lane 519, 547, 549, 551 going out of the intersection, if and only if a car is allowed to travel from the former to the latter across the intersection. isConnectorOnRoadSegment relates intersections to the lane connectors on them.

Equation (19) provides a definition of the concept Intersection.

$$Intersection ≡ ∃ {isConnectorOnRoadSegment}^{- 1} \cdot LaneConnector \qquad ( 19 )$$

Intersection instances were generated from ROAD SEGMENT records. The explicit spatial link between them and lane connectors was computed by checking whether a lane connector overlaps with an intersection. hasShape. To model the precise positions, shapes and sizes of all map elements described above, hasShape relations are introduced for each.

Each shape is represented with a subclass of the GeoSPARQL Simple Features (prefix sf) ontology concept sf: Geometry. It includes sf:Polygon, for example, which is used to model polygonal structures like walkways, lanes or intersections. Data properties of geometries store their precise shapes in nuScenes (x, y) coordinates, but also GPS coordinates, representing the real location on Earth.

This enables fusion with other geographic data sources and geospatial analysis. isOn, AreaElement. To create a connection between agents and the map, isOn relation is introduced. AreaElement is defined as a superclass for all map elements that occupy an area, i.e. have a sf:Polygon geometry. isOn links a SceneParticipant to the map object its currently on.

Equation (20) provides a definition of the concept AreaElement.

$$AreaElement ≡ Walkway ⋃ CarparkArea ⋃ Lane ⋃ LaneSnippet ⋃ RoadBlock ⋃ StopArea ⋃ PedCrossing ⋃ Intersection \qquad ( 20 )$$

A graph representation of the nSKG as a readily loadable dataset is prepared. It comes in the format of PyTorch Geometric (PyG) graphs. PyTorch Geometric (PyG) is one of the most widely used graph neural network libraries, so the dataset was prepared in PyG compatible format, readily loadable by PyG dataloaders. Formally, a heterogeneous graph G=(V, E, τ, ϕ) has nodes v∈V, with node types τ (v), and edges (u, v)∈E, with edge types ϕ(u, v). The edges are directed since they are based on properties of the knowledge graph.

Each example i in the constructed dataset is a pair (xᵢ, yᵢ)∈(G, R¹²), where xi is a scene graph with trajectory information from the past two seconds, local map, and target identifier and yi is the ground truth future trajectory of the target. This makes our dataset a graph regression task.

The constraints of 2 seconds into the past and 6 seconds into the future (sampled at 2 Hz) are kept from nuScenes, such that any results on our new graph dataset can be compared to those on nuScenes raw data. The training, validation, and testing splits from nuScenes are also preserved.

The coordinate system used was an important consideration as the right choice of coordinate system enables a data-centric inductive bias to be enforced, namely shift- and rotation-invariance. Inductive biases are widely considered to be essential for deep learning to generalize well.

Coordinates in the knowledge graph (and in nuScenes) are initially in a global coordinate system. These were transformed separately for each scene graph into local, scene graph-specific coordinates, with the origin at the location of the target agent and the positive x-axis pointing along the facing direction of the target. Precisely, let p_{target} and R_{target} be the global position (vector) and orientation (rotation matrix) of the target vehicle in scene graph g, respectively. Let p_{global}, R_{global} be arbitrary global position and global orientation, respectively. Their representation in the local frame is given by

Equations (21), (22) provide a definition of the concepts Plocal and Rlocal.

$${p}_{local} = {R}_{target}^{- 1} ( {p}_{global} - {p}_{target} ) \qquad ( 21 )$$

$${R}_{local} = {R}_{target}^{- 1} {R}_{global} \qquad ( 22 )$$

where R⁻¹_{target} is the inverse of the rotation matrix R_{target}. This way the coordinates of all entities in g can be transformed into the local coordinate system. Predictions automatically become shift- and rotation-invariant because any shifts and rotations are removed in the transformation.

All examples i have the target at the origin, oriented along the positive x-axis. It is empirically shown that this transformation improves trajectory prediction performance.

The trajectory information in a scene graph contains the Sequence 537, Scene, SceneParticipant and Participant nodes as well as the semantic relations between SceneParticipants. The object properties between them in the knowledge graph become heterogeneous edges.

The data properties of them are turned into node features. SPARQL queries were used to retrieve the past two seconds of Scene instances and the relevant agents in them. Relevant agents are those that may influence the target vehicle's motion, defined as those that are on a piece of relevant extracted map described next. This drops scene participants that are already behind the target agent from consideration, which is an improvement over prior work.

Besides trajectory information, a scene graph also contains the wealth of map information modelled in our ontology. However, including whole city maps is counterproductive and would make graphs unnecessarily large. The larger a graph, the more long-range dependencies can arise, posing problems for state-of-the-art graph neural networks. Only those parts of the map were considered that are potential paths of the target. To extract these from the knowledge graph, a target is mapped to the road block 627 it is on, and the hasNextRoadBlock edges are followed four blocks into the future.

Four road blocks 627 were chosen as the relevant length after analysing the distances travelled by agents within 6 seconds in nuScenes. Road blocks 627 are usually lane snippet length or more and a lane connector is about 5-10 m, so four road blocks 627 cover the future trajectory in most cases as agents do not usually travel more than 120 m, as our analysis revealed. Adding more into the future than necessary would make the graphs larger than necessary, hurting the performance of current graph neural networks. The surrounding map entities of the potential paths, walkways, carparks, pedestrian crossing and stop areas, etc. are extracted via the explicit spatial relations modelled in the ontology, described in the previous section.

These explicit spatial relations are also kept in the heterogeneous scene graphs and, just like all the other object properties, are converted into heterogeneous edges, as described previously. The connection between the extracted trajectory information and the map is made via the isOn relation, just as in the knowledge graph.

The constructed graph dataset contains more than 40,000 scene graphs and ground truth future trajectories. Each scene graph contains between 1,000 and 2,000 nodes on average. Graph neural networks trained on these scene graphs will have access to more information than any previous trajectory prediction method. It is likely that current state-of-the-art approaches will be outperformed with this representation by an appropriate graph neural network, since competing approaches do not have access to all information important for trajectory prediction.

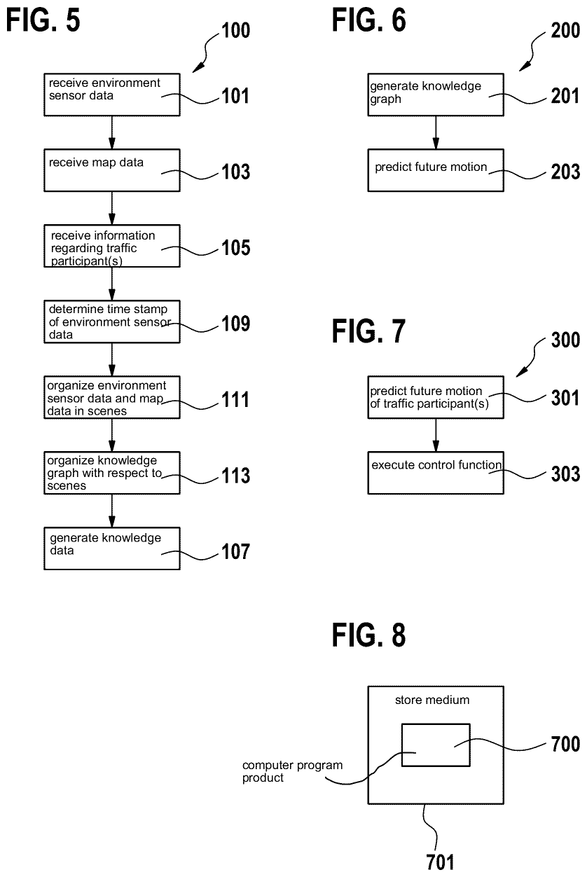

FIG. 5 shows a flow chart of a method 100 for generating a knowledge graph 400 for traffic motion prediction according to an embodiment.

For generating a knowledge graph 400 for traffic motion prediction in a first method step 101 environment sensor data 503 of at least one environment sensor 505 of the ego-vehicle 501 are received. The environment sensor data 503 thereby represent the environment of the ego-vehicle 501 and comprise information regarding at least one traffic participant 507 located in the environment of the ego-vehicle 501.

The environment sensor 505 can for example be a video camera, a radar sensor, an ultrasonic sound sensor or any other common environment sensor used in automated driving.

In a second method step 103 map data 509 from an electronic road map 511 are received. The map data 509 represent a road network 513 in the environment of the ego-vehicle 501 and comprise information regarding at least one motion track 515 the traffic participant 507 is position on.

The traffic participant 507 can be a static object, a moving object, a human, an animal, a vehicle, a car, a truck, a tram, a motorcycle, a bicycle, a barrier, a traffic cone or any other object that can be detected in a normal traffic scenario via the above-mentioned environment sensor 505.

Depending on the type of traffic participant 507 the motion track 515 can be a road 517, a lane 519, 547, 549, 551, an intersection, an underpath, a bridge, a motorway, a motorway access, a motorway exit, a roundabout 521, a parking bay, a parking lot, a bicycle lane, a tramway track, a pedestrian crossing 523, a sidewalk or any other piece of infrastructure in the environment of the ego-vehicle 501 that allows for a motion of the traffic participant 507.

In a further method step 105 the information regarding the at least one traffic participant 507 and the information regarding the motion track 515 are extracted from the environment sensor data 503 and the map data 509.

In a further method step 109 a time stamp t1, t2 of the environment sensor data 503, 509 is determined.

In a further method step 111 the environment sensor data 503 and the map data 509 are organized in scenes 533, 535 and sequences 537. A scene 533, 535 comprises the information of the environment sensor data 503 and the map data 509 for one time stamp t1, t2. The sequence 537 is a serious of successive scenes 533.

In a further method step 113 nodes 401 of the knowledge graph 400 are organized with respect to the scenes 533, 535 and the sequences 537 of the environment sensor data 503 and the map data 509.

In a further method step 107 the knowledge graph 400 comprising multiple nodes 401 and edges 403 is generated based on end extracted information regarding the traffic participant 507 and the motion track 515 of the map data 509 and the environment sensor data 503. The knowledge graph 400 hereby at least comprises nodes 401 presenting the information regarding the traffic participant 507 and nodes 401 representing the information regarding the motion track 515.

According to an embodiment, further information regarding the motion track 515 are included into the knowledge graph 400.

The further information can comprise, road geometries, lane geometries, lane dividers, lane boundaries, lane connectors, intersections, stop areas, traffic signals, traffic signs, traffic regulations, road conditions, slope values, pedestrian crossing, car park areas, road segments, road blocks 627 or any other feature of possible motion tracks 515 that can occur in a normal traffic scenario and that can affect the motion of the respective traffic participants 507.

In addition to the above-mentioned features of the traffic participant 507 further features regarding a relative position of the traffic participant 507 to either further traffic participants or to the ego-vehicle 501 can be included. The relative positions can comprise a longitudinal relative position 553, a transversal relative position 555 and/or an intersecting relative position 557.

According to a further embodiment, the information of the map data 509 considered in the knowledge graph 400 is limited to an area of a possible path of the traffic participant 507. Information regarding areas in the road network 513 which cannot be reached by the traffic participant 507 from its current position, are not introduced into the knowledge graph 400. This reduces the complexity of the knowledge graph 400 and simplifies the generation of the knowledge graph 400 as well as the computing power and storage capacity needed for generating and operating the knowledge graph 400.

According to an embodiment, the method 100 for generating a knowledge graph 400 for traffic motion prediction is executing during an operation mode, in particular during a driving mode, of the ego-vehicle 501.

FIG. 6 shows a flow chart of a method 200 for traffic motion prediction according to an embodiment.

For executing a motion prediction in a first method step 201 a knowledge graph 400 for traffic motion prediction is generated by executing the method 100 for generating a knowledge graph 400 for traffic motion prediction according to the above-mentioned embodiments.

In a further method step 203 a future motion of at least one traffic participant 507 positioned in an environment of the ego-vehicle 501 is predicted based on the knowledge graph 400 by a motion prediction module 539.

According to an embodiment the motion prediction module 539 comprises a trained artificial intelligence capable of predicting the motion of the traffic participant 507 based on the information of the knowledge graph 400.

The trained artificial intelligence can comprise a trained graph network.

FIG. 7 shows a flow chart of a method 300 for controlling an ego-vehicle 501 according to an embodiment.

For controlling an ego-vehicle 501 in a first method step 301 a future motion of at least one traffic participant 507 located in an environment of the ego-vehicle 501 is predicted by executing the method 204 traffic motion prediction according to the above-mentioned embodiments.

In a further method step 303 at least one control function of the ego-vehicle 501 based on the predicted motion of the at least one traffic participant 507 is executed.

The control function of the ego-vehicle 501 can comprise a steering function and/or acceleration or deceleration function and/or deceleration function of the ego-vehicle 501.

FIG. 8 shows a schematic representation of a computer program product 700 comprising instructions that, when executed by a data processing unit, cause the program to execute the method 100 for generating a knowledge graph for traffic motion prediction and/or the method 200 for traffic motion prediction and/or the method for controlling an ego-vehicle 501.

In the embodiment shown, the computer program product 700 is stored on a computing unit or storage medium 701. The storage medium 701 may be any storage medium from the related art.

What is claimed is:

1. A computer-implemented method for generating a knowledge graph for traffic motion prediction, comprising the following steps:
receiving environment sensor data of at least one environment sensor of an ego-vehicle, wherein the environment sensor data represent an environment of the ego-vehicle and include information regarding at least one traffic participant located in the environment of the ego-vehicle;
receiving map data from an electronic road map, wherein the map data represent a road network in the environment of the ego-vehicle and include information regarding at least one motion track the traffic participant is positioned on;
extracting the information regarding the at least one traffic participant from the environment sensor data, and extracting the information regarding the motion track the traffic participant is positioned on from the map data; and
generating a knowledge graph of the road network in the environment of the ego-vehicle including nodes and edges based on the map data and/or the environment sensor data, wherein the knowledge graph includes at least one node representing the traffic participant, and at least one node representing the motion track the traffic participant is positioned on.

2. The method according to claim 1, wherein the motion track the traffic participant is located on is at least one out of the following list: road, lane, intersection, underpass, bridge, motorway, motorway access, motorway exit, roundabout, parking bay, parking lot, bicycle lane, tramway track, pedestrian crossing, sidewalk.

3. The method according to claim 1, wherein the map data of the electronic road map include further information regarding further features of the motion track the traffic participant is located on, and wherein the at least one further feature of the motion track of the traffic participant is integrated into the knowledge graph via at least one further node.

4. The method according to claim 1, wherein the environment sensor data further include further information regarding at least one further feature of the traffic participant, and wherein the at least one further feature of the traffic participant is integrated into the knowledge graph via at least one further node.

5. The method according to claim 3, wherein the nodes and further node of the knowledge graph are organized in classes and sub-classes.

6. The method according to claim 3, wherein the further features of the motion track are at least one of the following list including: road geometries, lane geometries, lane dividers, lane boundaries, lane connectors, intersections, stop areas, traffic signals, traffic signs, traffic regulations, road conditions, slope values, pedestrian crossings, car park areas, road segments, road blocks.

7. The method according to claim 4, wherein the further features of the traffic participant are at least one of the following list including: i) static object, ii) moving object, iii) human, iv) animal, v) vehicle, vi) car, vii) truck, viii) tram, ix) motorcycle, x) bicycle, xi) barrier, xii) traffic cone, xiii) a relative position to at least one further traffic participant and/or to the ego-vehicle.

8. The method according to claim 1, further comprising:
determining a time stamp of the environment sensor data and of the map data;
organizing the environment sensor data and the map data in scenes and sequences, wherein a scene includes the information of the environment sensor data and the map data for one time stamp, and wherein a sequence is a series of successive scenes; and
organizing the nodes of the knowledge graph with respect to the scenes and sequences of the environment sensor data and the map data.

9. The method according to claim 1, wherein the information of the map data considered in generating the knowledge graph is limited to an area of a possible path of the traffic participant.

10. The method according to claim 1, wherein the method is executed during a driving operation of the ego-vehicle.

11. The method according to claim 1, further comprising:
predicting, by a motion prediction module, a future motion of at least one traffic participant positioned in the environment of an ego-vehicle based on the knowledge graph.

12. The method according to claim 11, wherein the motion prediction module includes a trained artificial intelligence capable of predicting the motion of the traffic participant based on information of the knowledge graph.

13. The method according to claim 11, further comprising:
executing at least one control function of the ego-vehicle based on the predicted motion of the at least one traffic participant.

14. A computing unit configured to generate a knowledge graph for traffic motion prediction, the computing unit configured to:
receive environment sensor data of at least one environment sensor of an ego-vehicle, wherein the environment sensor data represent an environment of the ego-vehicle and include information regarding at least one traffic participant located in the environment of the ego-vehicle;
receive map data from an electronic road map, wherein the map data represent a road network in the environment of the ego-vehicle and include information regarding at least one motion track the traffic participant is positioned on;
extract the information regarding the at least one traffic participant from the environment sensor data, and extracting the information regarding the motion track the traffic participant is positioned on from the map data; and
generate a knowledge graph of the road network in the environment of the ego-vehicle including nodes and edges based on the map data and/or the environment sensor data, wherein the knowledge graph includes at least one node representing the traffic participant, and at least one node representing the motion track the traffic participant is positioned on.

15. A non-transitory computer-readable storage medium on which is stored a computer program including instructions for generating a knowledge graph for traffic motion prediction, the instructions, when executed by a data processor, causing the data processor to perform the following steps:
receiving environment sensor data of at least one environment sensor of an ego-vehicle, wherein the environment sensor data represent an environment of the ego-vehicle and include information regarding at least one traffic participant located in the environment of the ego-vehicle;
receiving map data from an electronic road map, wherein the map data represent a road network in the environment of the ego-vehicle and include information regarding at least one motion track the traffic participant is positioned on;
extracting the information regarding the at least one traffic participant from the environment sensor data, and extracting the information regarding the motion track the traffic participant is positioned on from the map data; and
generating a knowledge graph of the road network in the environment of the ego-vehicle including nodes and edges based on the map data and/or the environment sensor data, wherein the knowledge graph includes at least one node representing the traffic participant, and at least one node representing the motion track the traffic participant is positioned on.
